(19) United States
(12) Patent Application Publication
(10) Pub. No.: US 2008/0170806 A1
(43) Pub. Date: Jul. 17, 2008

(54) 3D image processing apparatus and method

(75) Inventor: Hyun Sool Kim, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/006,850

(22) Filed: Jan. 7, 2008

(30) Foreign Application Priority Data
Jan. 12, 2007 (KR) 2007-0003833

(51) Int. Cl. G06K 9/36

(52) U.S. Cl. 382/285

(57) ABSTRACT

A 3d image processing apparatus and method for generating a three-dimensional (3D) image from two-dimensional (2D) images are provided. An image file format of the present invention includes an image start segment for indicating a start of an image file; an image information segment for storing information on the image file; a two-dimensional image segment for storing first two-dimensional image data; and an image end segment for indicating and end of the image file, wherein the image information segment comprises a variable length information field for storing information indicating the image information segment contains three-dimensional image and three-dimensional image data.

### CROSS-REFERENCE TO RELATED APPLICATION(S) AND CLAIM OF PRIORITY

This application claims priority to an application entitled “3D IMAGE PROCESSING APPARATUS AND METHOD” filed in the Korean Intellectual Property Office on Jan. 12, 2007 and assigned Serial No. 2007-0003833, the contents of which are incorporated herein by reference.

### TECHNICAL FIELD OF THE INVENTION

The present invention relates to an image processing technique and, in particular, to a 3D image processing apparatus and method for generating a three-dimensional (3D) image using two-dimensional (2D) images.

### BACKGROUND OF THE INVENTION

Recently, mobile phones have developed into intelligent devices that support various multimedia functions. The digital camera is one of the important features in multimedia-capable mobile phones. An image taken by a built-in camera can be presented on a display of the mobile phone or transmitted to another mobile phone. Typically, an image processing apparatus processes a 2D image taken by a single camera.

It is known that the left and right views of human eyes see an object differently. The left and right images are combined in the brain so as to be presented as a three-dimensional image. Similarly, a 3D image can be obtained by combining multiple images taken by multiple cameras.

A general image processing apparatus is provided with an image codec having a 2D image processing capability. Accordingly, the image processed by 3D image processing apparatus cannot be normally presented on a display. That is, the display device having a 2D image processing capability is limited in displaying 3D images. This is because no standard 3D file format is compatible with a general 2D image processing codec.

### SUMMARY OF THE INVENTION

To address the above-discussed deficiencies of the prior art, it is a primary object of the present invention to solve the above problems. In order to solve the above problems, the present invention provides a data processing apparatus and method for generating a 3D image from a 2D image.

In accordance with an aspect of the present invention, an image file format includes an image start segment for indicating a start of an image file; an image information segment for storing information on the image file; a two-dimensional image segment for storing first two-dimensional image data; and an image end segment for indicating an end of the image file, wherein the image information segment comprises a variable length information field for storing information indicating whether the image information segment contains three-dimensional image and three-dimensional image data.

In accordance with another aspect of the present invention, an image processing apparatus includes a first camera and a second camera installed with a predetermined distance for obtaining a first and a second image respectively; a video processing unit for generating a three-dimensional image by combining the first image and the second image; a control unit for controlling generation of an image file using the first image and the three-dimensional image; a memory unit for storing the image file; and a display unit having a parallax barrier for displaying the three-dimensional image with a three-dimensional effect or as a 2-dimensional image under a control of the control unit.

In accordance with another aspect of the present invention, an image storage method for an image processing apparatus having a first and a second camera installed with a predetermined distance includes capturing a first image and a second image input from the cameras; generating a three-dimensional image by combining the first image and the second image; and storing the three-dimensional image as an image file.

In accordance with an aspect of the present invention, an image processing method for an image processing apparatus having a first camera and a second camera installed with a predetermined distance includes obtaining a first image and a second image by using the first camera and the second camera; generating an image file generated by encoding the first image and the second image in an image storage mode; and producing a three-dimensional image by decoding the first image and the second image from the image file and combining the first image and the second image.

In accordance with another aspect of the present invention, an image processing method for an image processing apparatus having a first camera and a second camera installed with a predetermined distance includes switching on a three-dimensional image display function of a display with activations of the first camera and the second camera in a three-dimensional image processing mode; displaying a three-dimensional image generated by combining a first image and a second image input from the first camera and the second camera; storing an image file produced by encoding the first image and the three-dimensional image in an image recording mode; and replaying the three-dimensional image reproduced by decoding the three-dimensional image from the image file in an three-dimensional image replay mode.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an image processing apparatus according to an exemplary embodiment of the present invention;

FIGS. 2A-2C are diagrams illustrating 3D image processing steps of an image processing method according to an exemplary embodiment of the present invention;

FIGS. 3A and 3B are diagram illustrating file formats of a 3D image generated by the image processing apparatus of, FIG. 1;

FIGS. 4A and 4B are block diagrams illustrating configurations of the video processing unit of the image processing apparatus of FIG. 1;

FIG. 5 is a flowchart illustrating a 3D image recording procedure of a 3D image processing method according to an exemplary embodiment of the present invention;

FIG. 6 is a flowchart illustrating a 3D image playback procedure of a 3D image processing method according to an exemplary embodiment of the present invention;

FIG. 7A is a pair of perspective views illustrating mobile terminals equipped with two cameras for implementing an image processing method according to an exemplary embodiment; and

FIG. 7B is a diagram illustrating a configuration of each mobile terminal of FIG. 7A.

### DETAILED DESCRIPTION OF THE INVENTION

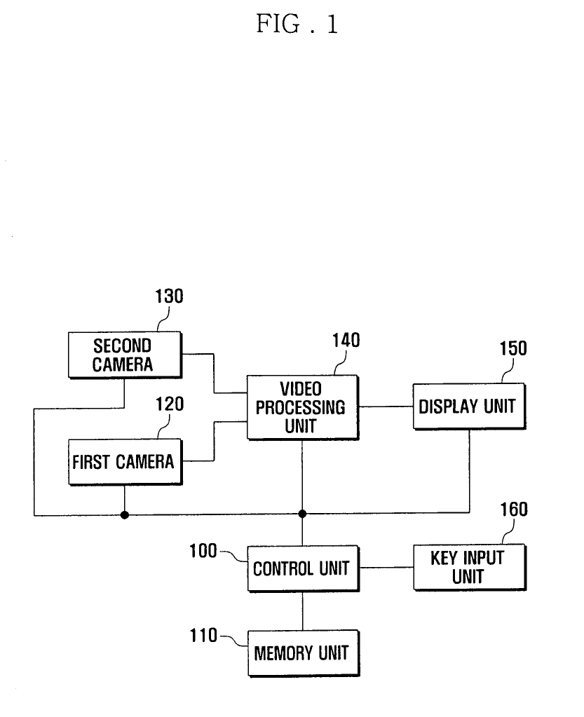

FIGS. 1 through 7B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged 3D image processing system.

In the following, the term “two-dimensional image” or “2D image” denotes an image taken by a camera; “three-dimensional image” or “3D” denotes an image generated by combining images taken by at least two cameras; and “image information” denotes information attached to an image in association with image file format. The image information includes quantization information, coding scheme information, application information, etc.

In the following description, images are processed by a Joint Photographic Experts Group (JPEG) codec. However, the image processing of the present invention can be implemented with another image codec for processing still and motion images. Although two cameras are employed for capturing two different images as in the human viewing system, the present invention is not limited there. For example, more than two cameras can be applied for the 3D image processing apparatus of the present invention.

In the following description, it is assumed that a 3D image is an image represented by a pair of image packed in a file. The paired images are called a left eye image and a right eye image, respectively. In the following description, it is assumed that the image processing apparatus is compatible with a general JPEG file viewer and capable of processing 3D images. The image processing apparatus of the present invention is provided with a display device capable of displaying 2D and 3D images.

In the following description, a set of stereo images are obtained by at least two cameras, one of the stereo images is stored as a 2D image, and a 3D image is generated by combining the set of stereo images. The 3D image is generated by inserting the left and right eye images line by line. The rest 2D images also can be stored independently and then used for generating the 3D image. In the case the 2D images are inserted line by line at a presentation time point.

In the following description, a 3D image file is structured on the basis of typical JPEG file format. 2D image data are stored within a JPEG data region of the JPEG file format. The 3D image data are stored within a comment segment or an application segment of the JPEG file format in the form of a compressed or uncompressed data. The application segment can be an exchangeable image file format (Exif) segment, and the 3D image can be stored in a thumbnail segment of the Exif segment. In the case that the 3D image is stored in the thumbnail segment of the Exif segment, 2D image display device may display the thumbnail image abnormally. In order to prevent the thumbnail image from being displayed abnormally, it is required to modify the header of the 3D image file or insert information indicating the 3D image into the header of the 3D image file.

The image is stored with an identifier which is inserted into a user comment field of the Exif segment for indicating that the image data is a 3D image file. The 3D information can be inserted into another field of the Exif segment or the header of the JPEG file (before the 3D thumbnail data).

When displaying the 2D or 3D image stored in the JPEG file format, the image processing apparatus checks whether the image stored in the JPEG file is 2D image or 3D image. That is, the image processing apparatus checks the comment segment or another specific segment configured to carry the image information for determining whether the image is a 2D image or 3D image. If the image file contains a 2D image, the image processing apparatus process the image file in a normal 2D image processing scheme. On the other hand, if the image file contains a 3D image, the image processing apparatus processes the 3D image stored within the comment region or the thumbnail region in a 3D image processing scheme.

In the following, the image processing apparatus and method are described under the assumption that a 3D image is generated by combining 2D images taken by two cameras. However, the 3D image can be achieved using still images and animation images downloaded by a 3D graphic application. That is, 2D images for use in generation of a 3D image can be obtained using a graphic application as well as using the cameras.

FIG. 1 is a block diagram illustrating a configuration of an image processing apparatus according to an exemplary embodiment of the present invention. In this embodiment, a pair of left and right eye images for generating a 3D image is obtained using two cameras. However, the left and right eye images can be obtained using a graphic application or downloaded from a web or another device.

Referring to FIG. 1, the image processing apparatus includes a control unit 100, a memory unit 110, a pair of first and second cameras 120 and 130, a video processing unit 140, a display unit 150, and a key input unit 160.

The first and second cameras 120 and 130 have different sights of an object as both human eyes do.

The video processing unit 140 includes a combiner for generating a stereo image, i.e. 3D image, by combining 2D images obtained through the first and second cameras 120 and 130, a video encoder for encoding the 2D images and/or the 3D image, and video decoder for decoding the encoded 2D and 3D images. The video processing unit 140 can be provided with a video encoder for encoding the 2D images obtained from the first and second cameras 120 and 130, a video decoder for decoding the encoded 2D images, and a combiner for generating a 3D image by combining the decoded 2D images. The video processing unit 140 may further include a scaler for scaling sizes of the images output from the cameras 120 and 130 or the image output from video decoder to match the screen size of the display unit 150 and a color converter for converting the color data of the images output from the cameras 120 and 130 into those of the display unit 150. In this embodiment, it is assumed that the video encoder and decoder are JPEG coder and decoder.

The display unit 150 is provided with a display panel that can selectively display both the 2D and 3D images. That is, the display unit 150 allows the 3D image to appear on the screen as if it is viewed with two eyes.

As an example of a commercialized 3D display, Sharp has introduced a laptop computer equipped with a 3D display called RD3D, which is implemented with two active matrix liquid crystal display (LCD) panels sandwiched a parallax barrier. The rear LCD panel is transparent in 2D mode, but turns on to provide depth information delayed by the parallax barrier in 3D mode. The display unit 150 operates in 2D or 3D mode under the control of the control unit 150.

The key input unit 160 generates a command signal for controlling the operation of the image processing apparatus. The key input unit 160 also generates a command signal for switching between 2D and 3D modes in response to user's key input.

The control unit 100 controls general operations in the 2D and 3D mode of the image processing apparatus. In 2D mode, the control unit 100 activates one of the cameras (here, the first camera 120) in the 2D mode and controls the video processing unit 140 to disable the combiner such that 3D mode functions are off. Accordingly, the image obtained by the first camera 120 is presented on the screen of the display unit 150 as a flat 2D image. In the 3D mode, the control unit 100 activates both the first and second cameras 120 and 130, the combiner of the video processing unit 140, and the 3D function of the display unit 150. Accordingly, the video processing unit 140 generates a 3D image by combining 2D images taken by the first and second camera 120 and 130 and displays the 3D image on the screen of the display unit 150.

The memory unit 110 stores the 2D and 3D images encoded by the video processing unit 140 under the control of the control unit 100. In this embodiment, the images are stored within the memory unit 110 in the JPEG format. In the 3D mode, the control unit 110 stores the 2D image data obtained by a predetermined camera (here, the first camera 120) together with information on the 3D image or the 2D image obtained by the other camera (here, the second camera 130). The image information is contained in the image information region.

The operations of the above-structured image processing apparatus are described hereinafter.

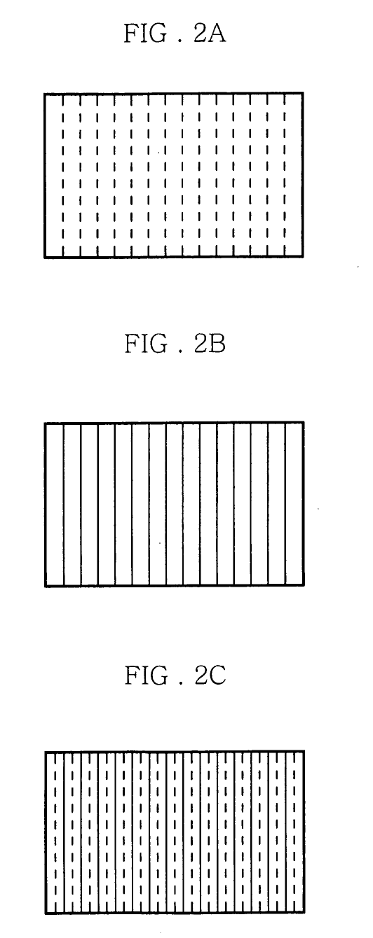

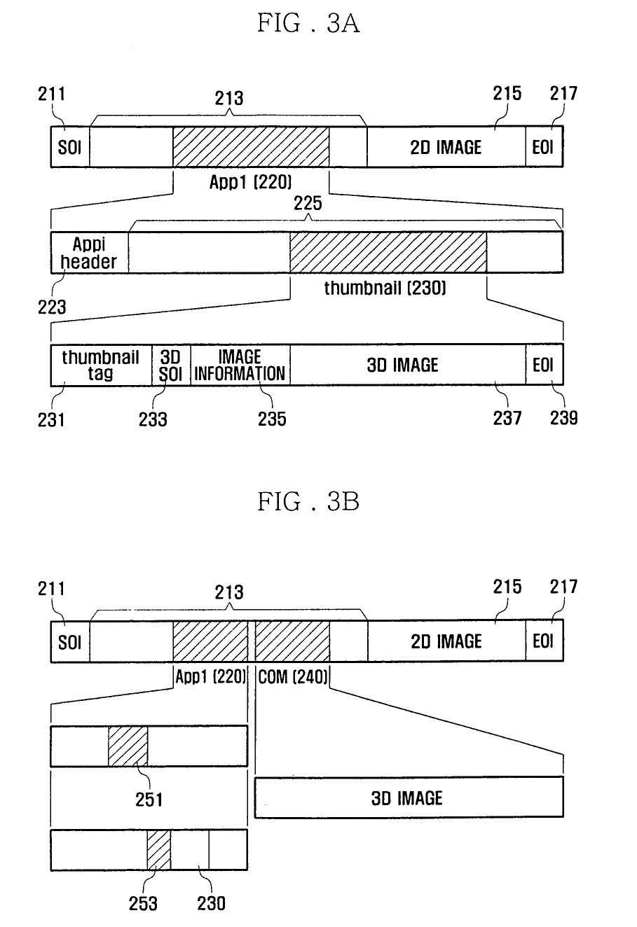

FIGS. 2A-2C are diagrams illustrating 3D image processing steps of an image processing method according to an exemplary embodiment of the present invention, and FIGS. 3A and 3B are diagram illustrating file formats of a 3D image generated by the image processing apparatus of FIG. 1.

The 2D images obtained from the first and second cameras 120 and 130 are presented as shown in FIGS. 2a and 2b, respectively. Since the first and second cameras 120 and 130 are installed with a predetermined distance, the images taken by the first and second cameras 120 and 130 differ from each other. If the images are received from the first and second cameras 120 and 130, the video processing unit 140 interlaces the first image from the first camera 120 and the second image from the second camera 130 by column so as to generate a combined image as shown in FIG. 2c. By interlacing the first and second image, the combined image is shown as 3D image.

Now, how the 2D and 3D images are recorded is described. In this embodiment, it is assumed that the image files are stored in the JPEG file format.

As shown in FIGS. 3A and 3B, the JPEG file format is composed of marker segments: an SOI (start of image marker) segment 211, an image information segment 213 for containing image information, a 2D image segment 215 for containing image data, and an EOI (end of image marker) segment 217. The 2D image segment 215 contains basic image data (here, the image data output by the first camera 120). The SOI is a 2 byte long marker code indicating the start of compressed data and is set to FFD8 for 2D image. The image information segment 213 contains quantization, coding scheme, and capturing information. That is, the information includes define quantization table (HQT), define Huffman table (DHT), start of frame (SOF), start of scan (SOS), application, comment, etc. The JPEG marker segments are listed in Table 1.

TABLE 1
SO1
APP1
COM
DQT
DHT
SOF
SOS
Image data
EOI

In this embodiment, the 3D image or the auxiliary 2D image (obtained through the second camera) for generating the 3D image are contained in an application information segment (APP1) 220 as shown in FIG. 3A or a comment information segment 240 as shown in FIG. 3B.

The video processing unit 140 can be configured to generate the 3D image by combining the first and second images and then encode the images. In this case, the first image obtained through the first camera 120 and the combined image is compressed. The compressed first image is recorded in the 2D image segment 215 and the compressed 3D image is recorded in the APP1 segment 220 or comment segment 240 of the image information segment 213.

How the 3D image is recorded within the APP1 segment 220 is described hereinafter with reference to FIG. 3A.

The control unit 100 sets the SOI segment 211 with a marker code “FFD8” for indicating 2D JPEG image and records the first image data in the 2D image segment 215. The control 100 controls such that the 3D image is contained in a thumbnail segment 230 of the APP1 segment 220. The APP1 segment 220 can contains Exif information. The Exif information can include a thumbnail image and detailed information such as a shoot date and time, image size, exposure time, exposure program, focal length, and F-number. The thumbnail image is contained in a thumbnail image segment 230 which is variable in size. In this embodiment, the thumbnail image segment 230 contains 3D image data and information on the 3D image rather than the 2D thumbnail image of the image contained in the 2D image segment. That is, the thumbnail image segment 230 of the image information segment 213 contains image data and information required for generating 3D image data rather than containing the thumbnail image representing the 2D image data stored in the 2D image segment 215.

In the case that the thumbnail image segment 230 contains 3D image information as shown in FIG. 3A, the thumbnail image segment 230 includes a thumbnail tag segment 231 for indicating that the thumbnail image segment 230 carries a thumbnail image, a 3D SOI segment 233, an image information segment 235, a 3D image segment 237, and an EOI segment 239. Here, the 3D SOI segment 231 carries information different from that of SOI segment 211. The SOI segment 211 is a marker set to “FFD8” indicating the 2D image. Thus, the marker of the 3D SOI segment 233 is set to a value for indicating the 3D image.

In the first 3D image recording scheme, the information on the first image, which is a 2D image, is recoded in a first image data segment, and a marker indicating a 3D image and 3D image data are recorded in the APP1 segment as shown in Table 2. The JPEG file format can be structured as shown in Tables 2 and 3. The APP1 segment records one of the compressed 3D image, compressed second image, uncompressed 3D image, and uncompressed second image.

TABLE 2
SOI
APP1
Record 3D image data and information
indicating 3D image in thumbnail
segment of Exif segment
COM
DQT
DHT
SOF
SOS
First image data (2D image data)
EOI

TABLE 3
thumbnail tag
SOI
(modified for indicating 3D image)
COM
DQT
DHT
SOF
SOS
Compressed 3D image data
(or compressed second image data,
uncompressed 3D image, or uncompressed
second image data)
EOI

How the 3D image is recorded within the APP1 segment 220 is described hereinafter with reference to FIG. 3B.

The control unit 100 sets the SOI segment 211 with a marker code “FFD8” for indicating 2D JPEG image and records the first image data in the 2D image segment 215. Next, the control unit 100 controls to record image information indicating 3D image in the image information segment 213 and records the 3D image data in the COM segment 240. The APP1 segment 220 may record Exif information, and a user comment segment 251 of the APP1 segment 220 may record information indicating a 3D photograph. That is, the COM segment 240 records the 3D image data, the user comment segment 251 of the APP1 segment 220 is set for indicating that the COM segment 240 contains the 3D image data.

The 3D image indication information can be recorded in another segment of the Exif or a header segment 253 of the JPEG file (for example, prior to the comment segment 240).

As described above, in the second 3D image recoding scheme, the first 2D image data are recorded within the 2D image segment 215, a 3D image indicator is recorded within the APP1 segment 220 of the image information segment 213 (here, before the user comment field or thumbnail field of the Exif data), and the 3D image data are recorded within the COM segment 240. In this manner, one JPEG file can contain the 2D image and 3D image simultaneously. At this time, the JPEG file format can be structured as in Tables 4 and 5. The image data recorded within the 3D image data storage region can be a compressed 3D image data, compressed second image data, uncompressed 3D image data, or uncompressed second image data.

TABLE 4
SOI
APP1
Header information indicating that the
3D image is recorded in Exif user
comment segment
COM
Compressed 3D image data
(compressed second image data,
uncompressed 3D image data, or
uncompressed 2D image data)
DQT
DHT
SOF
SOS
First image data (2D image data)
EOI

TABLE 5
SOI
APP1
3D indication information can be
inserted in any segment of Exif or
prior to the COM segment.
COM
Compressed 3D image data
(compressed second image data,
uncompressed 3D image data, or
uncompressed 2D image data)
DQT
DHT
SOF
SOS
First image data (2D image data)
EOI

As described above, the 3D image recording scheme records the first image data in the 2D image segment 215 and records the 3D image marker and 3D image (including data and information) in the specific region of the image information segment 213. Accordingly, 2D and 3D image can be stored within a signal JPEG file.

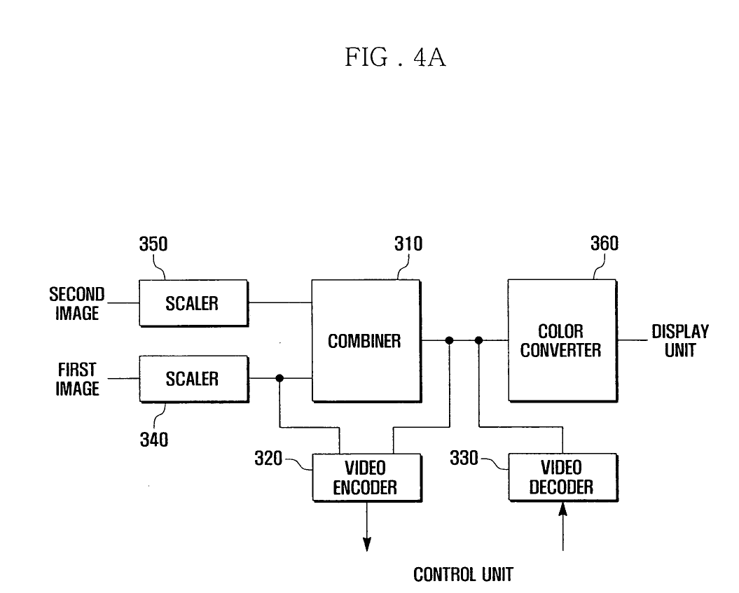

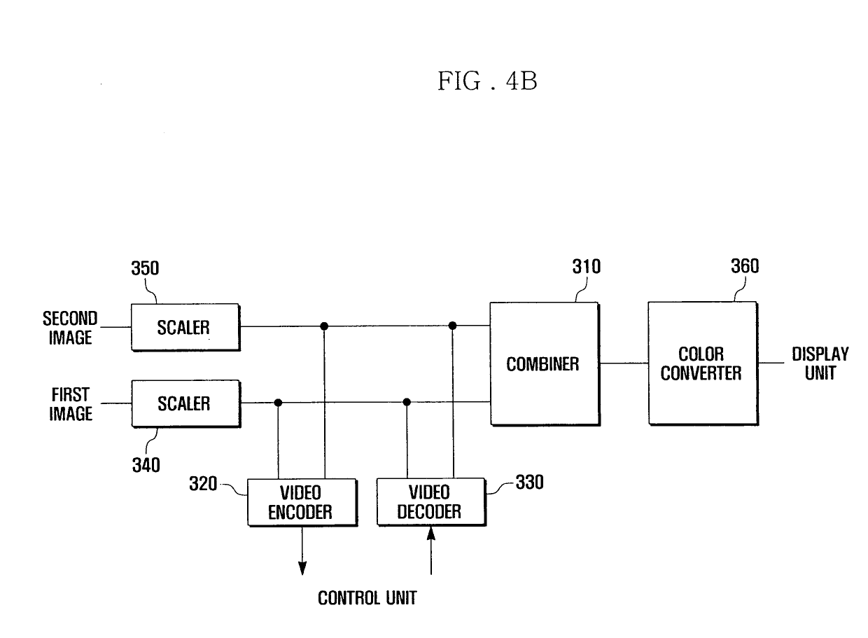

FIGS. 4A and 4B are block diagrams illustrating configurations of the video processing unit of the image processing apparatus of FIG. 1.

Referring to FIG. 4A, the video processing unit 140 is configured so as to generate a 3D image by combining the video data output by the first and second cameras 120 and 130 and encode the 3D image to be compatible with the stand JPEG file format.

In FIG. 4B, the video processing unit 140 is configured so as to store the first and second images obtained through the first and second cameras 120 and 130 as a single JPEG file by encoding the first and the second images, and generate a 3D image by decoding the JPEG file and combining the first and second imaged. In FIGS. 4A and 4B, the video encoder 320 and video decoder 330 can be implemented as a JPEG codec.

Referring to FIG. 4A, the video processing unit 140 includes a pair of scalers 340 and 350, a combiner 310, a video encoder 320, a video decoder 330, and a color converter 360.

The scalers 340 and 350 performs scaling on the size of the first and second images obtained by the first and second cameras 120 and 130 to match the screen size of the display unit 150. The cameras 120 and 130 are installed with a predetermined distance and activated simultaneously in the 3D mode so as to take first and second image, respectively. Preferably, the first and second cameras 120 and 130 are arranged with a distance similar to that between two eyes of a human such that the first and second images are regarded as the images perceived by the left and right eyes. The video encoder 320 encodes the first image output from the first scaler 340 in the JPEG format, and the combiner 310 combines the first and second images so as to generate a 3D image. The video encoder 320 encodes the 3D image output from the combiner 310 in the JPEG format.

The encoded image file can be structured in the file format of FIG. 3A or FIG. 3B. In this case, the image information segment 213 records the information on the first image and the 3D image and the 3D image data, and the 2D image segment 215 records the first image data. The combined image data output from the combiner 310 are recorded within the APP1 segment 220 of the image information segment 213 as 3D image information and data as shown in FIG. 3A or FIG. 3B.

The control unit 100 controls the video encoder 320 to generate the 3D JPEG file by processing the first image and the 3D image and stores the 3D JPEG file within the memory unit 110. Although the first image and 3D image are encoded to be stored in a compressed 3D JPEG format in FIG. 4A, the 3D image can be stored in an uncompressed format. In this case, the video encoder 320 does not encode the 3D image, and the control unit 100 stores the raw 3D image within the memory unit 110 in the 3D JPEG file format. The 3D JPEG file format can be structured as in Tables 2 to 5.

The 3D image stored within the memory unit 110 is displayed as follows. The control unit 100 accesses a JPEG file stored in the memory unit 110 and analyzes the information contained in the APP1 segment of the image information region 213. If 3D image indication information is retrieved from the Exif user comment segment or thumbnail segment, the control unit 100 regards the JPEG file is a 3D JPEG file and transfers the coded 3D image to the video decoder 330. The video decoder 330 decodes the coded 3D image and outputs the decoded 3D image to the color converter 360. The color converter 360 converts the color of the decoded 3D image to match that of the display unit 150. At this time, the control unit 100 controls the display unit 150 to display the 3D image such that the display unit 150 displays the 3D image output from the color converter 360.

Referring to FIG. 4B, the video processing unit 140 includes a pair of scalers 340 and 350, a combiner 310, a video encoder 320, a video decoder 330, and a color converter 360.

The scalers 340 and 350 performs scaling on the size of the first and second images obtained by the first and second camera 120 and 130 to match the screen size of the display unit 150. The video encoder 320 encodes the first and second images output from the first and second scalers 340 and 350 in the JPEG format.

The control unit 100 controls the video encoder 320 to generate a 3D JPEG file using the first and second images and store the 3D JPEG file within the memory unit 110. At this time, the 3D image can be obtained by combining the first and second image or only from the second image. In FIG. 4A, the first image and the 3D image obtained by combining the first and second image are encoded so as to be stored in the 3D JPEG file format. In FIG. 4B, the first and second images are encoded so as to be stored in the 3D JPEG file format. The 3D image and the second image to be used as the 3D image can be stored in uncompressed image format. In this case, the video coder 320 is disabled and the control unit 100 controls such that the encoded first image and the raw second image are stored within the memory unit 110 in the 3D JPEG file format. The 3D JPEG file formats can be structured as in Tables 2 and 5.

The 3D image stored within the memory unit 110 is displayed as follows. The control unit 100 accesses a JPEG file stored in the memory unit 110 and analyses the information contained in the APP1 segment of the image information region 213. If 3D image indication information is retrieved from the Exif user comment segment or thumbnail segment, the control unit 100 regards the JPEG file is a 3D JPEG file and transfers the coded 3D image to the video decoder 330. The video decoder 330 decodes the first and second images and the combiner 310 combines the first and second images so as to output a 3D image to the color converter 360. The color converter 360 converts the color of the 3D image to match that of the display unit 150 and the display unit 150 displays the 3D image output from the color converter 350. As described above, the display unit 150 is configured so as to selectively display the 2D and 3D images. The display unit 150 can be implemented with a liquid crystal display (LCD) having a 3D presentation capability. In this case, the display unit 150 can be composed of a conventional 2D active matrix display panel and an auxiliary matrix display panel called parallax barrier in which the auxiliary matrix display panel is transparent in a 2D mode and provides left and right eye image information alternately in a 3D mode. If the 3D display mode is activated, the two active matrix display panels operate to display the image three-dimensionally.

In FIGS. 4A and 4B, the first and second images taken by the first and second cameras 120 and 130 are scaled by the scalers 340 and 350 in size, and combined to be output as a 3D image. The 3D image is converted such that its color is to match that of the display unit 150. However, the first and second images can be input to the combiner 310 and video encoder 320 before being scaled by the scalers 340 and 250 or after being converted in color by the color converter 360.

The combiner 310 can be implemented with at least one buffer. Since the combiner 310 combines the first and second images for generating a 3D image, buffers can be used to adjust the input timing of the first and second image data for generating the 3D image.

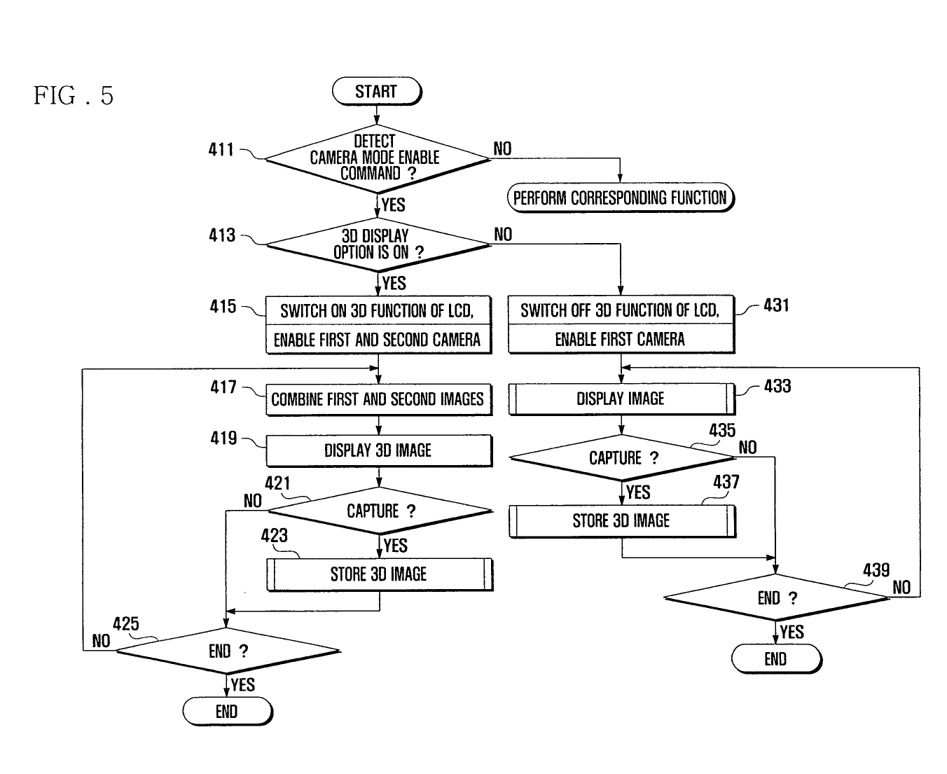

FIG. 5 is a flowchart illustrating a 3D image recording procedure of a 3D image processing method according to an exemplary embodiment of the present invention.

Referring to FIG. 5, the control unit 100 monitors to detect an input command and determines, if an input command is detected, whether the command is a camera mode enable command (S411). If the input command is the camera mode enable command, the control unit 100 determines whether a 3D display option is switched on (S413). That is, the display unit can be set for selectively displaying 2D and 3D images.

If a 3d display option is switched on, the control unit 100 activates both the cameras 120 and 130 and enables the display unit to operate in the 3D display mode (S415). The cameras 120 and 130 capture 2D images and the display unit 150 enables the parallax barrier such that the 2D images are combined to be shown as a 3D image. Here, the first and second images (see FIGS. 2A and 2B) obtained by the first and second cameras 120 and 130 are combined so as to be output as a 3D image (see FIG. 2C). The display unit 150 displays the 3D image on the screen under the control of the control unit 100.

In a case that the display unit 150 is provided with two active matrix display panels, the control unit activates both the two active matrix panels for displaying an image three-dimensionally. Since the 3D image is generated by combining the first and second image, the image is shown with three-dimensional effect. The images obtained by the first and second cameras 120 and 130 are presented in the form of a 3D preview image.

If a capture command is detected, the control unit 100 processes the first and second images and stores the images in the form of a 3D JPEG file. The 3D JPEG file is stored in the format of FIG. 3A or FIG. 3B (see Tables 2 to 5). That is, the 3D JPEG file is recorded within the comment segment or Exif thumbnail segment in the form of compressed or uncompressed 3D data. How the 3D data is recorded within the thumbnail segment of Exif is depicted in FIG. 3A with reference to Tables 2 and 3 in which the 3D data are stored by modifying the header of the 3D image or inserting a 3D image indication information prior to the 3D data such that the 3D images is displayed as a thumbnail. This is because, if the 3D image is perceived as a thumbnail image, the thumbnail is abnormally displayed in another device. In the case that the 3D image is stored within the comment segment, as shown in FIG. 3B with reference to Tables 4 and 5, 3D image indication information is inserted into the comment segment. That is, in order to indicate that the comment segment contains the 3D image, a 3D indicator is inserted into the user comment field of Exif segment or a header segment of JPEG file (here, front part of the thumbnail segment).

The 3D image can be an image obtained by combining the first and second images or a second image to be combined with the first image. The control unit 100 stores the 3D image in a predetermined segment of the JPEG file formation. The predetermined segment can be a thumbnail segment or comment segment of Exif. The header information for indicating the presence of the 3D image can be contained in a comment segment, or prior to or inside of the thumbnail segment.

The 3D image can be a compressed image coded by the video encoder 320 or an uncompressed image. In the case of compressed image, a 3D JPEG file is generated in the above manner. In the case of uncompressed image, the control unit 100 stores the first image captured by the second camera 130 or the combined image output by the combiner 310 in a predetermined segment of the 3D JPEG file.

The 3D image generated by combining the first and second images at step S417 is displayed as a 3D image (S419).

Next, the control unit 100 monitors and detects an input command and determines whether the input command is a capture command (S421).

If the input command is not a capture command, the control unit determines whether the input command is a termination command (S425). If the input command is a termination command, the control unit 100 deactivates the first and second cameras 120 and 130 and then exits the 3D image processing mode.

If it is determined that the input command is a capture command, the control unit 100 controls to record the 3D image (S423).

If it is determined that the 3D image option is switched off at step S413, the control unit 100 turns on only the first camera 120 and disables the 3D image display function (S431). The 3D image display function should be disabled because the 2D image may be abnormally displayed in the 3D image display function. Since only the first image is input, the combiner 210 bypasses the first image. Accordingly, the control unit 100 controls the display unit to display the first image as a 2D image (S433). While displaying the first image, the control unit 100 monitors to detect an input command and determines, if an input command is detected, whether the input command is a capture command (S435). If the input command is the capture command, the control unit 100 controls to record the first image as 2D image (S437). At this time, the image information segment 213 contains the information on the first image, and the thumbnail segment 230 of the image information segment 213 contains a thumbnail of the first image in the 2D image format. The image recording process is maintained until a termination command is detected. If a termination command is detected (S439), the control unit 100 ends the 2D image processing mode.

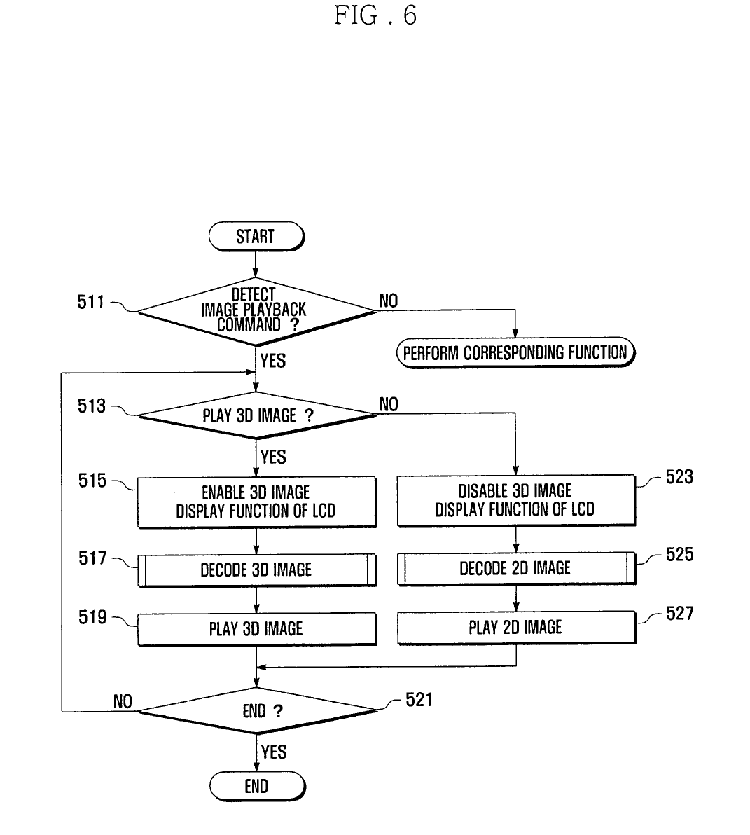

FIG. 6 is a flowchart illustrating a 3D image playback procedure of a 3D image processing method according to an exemplary embodiment of the present invention.

Referring to FIG. 6, the control unit 100 monitors and detects an input command and determines, if an input command is detected, whether the input command is an image playback command (S511). If the image playback command is detected, the control unit 100 analyzes a target image and determines whether the target image is a 3D image (S513). That is, the control unit analyzes the header information of the JPEG image file and determines the image contained in the JPEG image file is a 2D image or a 3D image on the basis of the analysis result. As described above, the 3D JPEG file contains 3D information in the SOI segment of the thumbnail segment, user comment segment of Exif, or another specific segment of the Exif. If it is determined that the JPEG image file is a 3D image file, the control unit 100 controls the display unit 150 to enable the 3D display function (S515) such that the 3D image is decoded (S517) and displayed on the screen of the display unit 150 (S519).

The 3D image playback can be performed in different manner according to whether the image is stored in the thumbnail segment or the comment segment. That is, if the 3D image is generated by combining and encoding the images obtained through two cameras 120 and 130, control unit 100 controls the video decoder 330 to decode the 3D image (S517) and displays the decoded 3D image on the screen of the display unit 150 (S519). On the other hand, if the 3D image is an encoded 2D image, the control unit 100 controls the video decoder 330 of the video processing unit 140 to decode the first and second images from the encoded 2D image and combine the first and second image as shown in FIG. 2C such that the combined 3D image is displayed on the screen of the display unit 150. If the 3D image is an uncompressed combined image, the control unit 100 controls the display unit 150 to directly display the uncompressed image. If the 3D image is an uncompressed 2D image, the control unit 100 controls the video decoder 330 of the video processing unit 140 to decode the first image and controls the combiner 310 to combine the decoded first image and uncompressed second image for generating the 3D image as shown in FIG. 2C such that the 3D image is displayed on the screen of the display unit 150.

If it is determined that the image contained in the JPEG image file is a 2D image at step S513, the control unit 100 controls the display unit 150 to disable the 3D display function (S523) such that the 2D image is decoded and displayed on the screen of the display unit 150 (S527).

The image processing apparatus can be applied to a mobile terminal having multiple digital cameras.

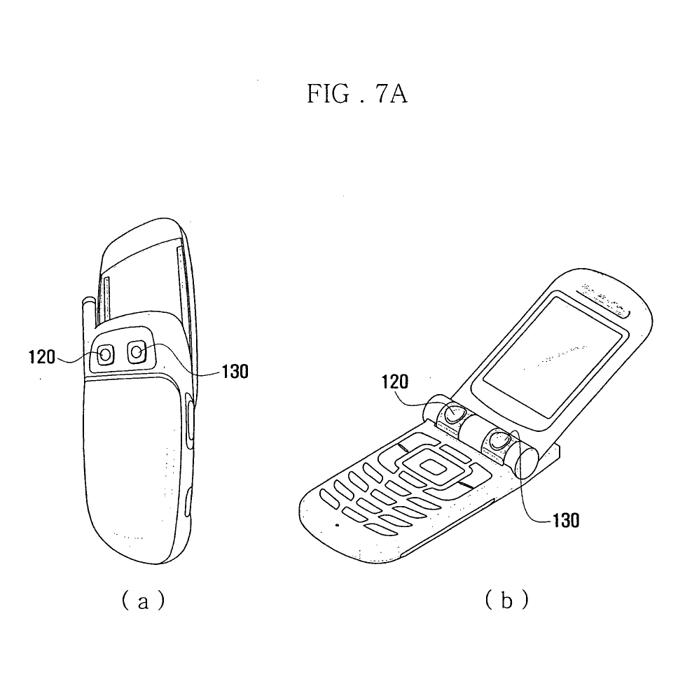

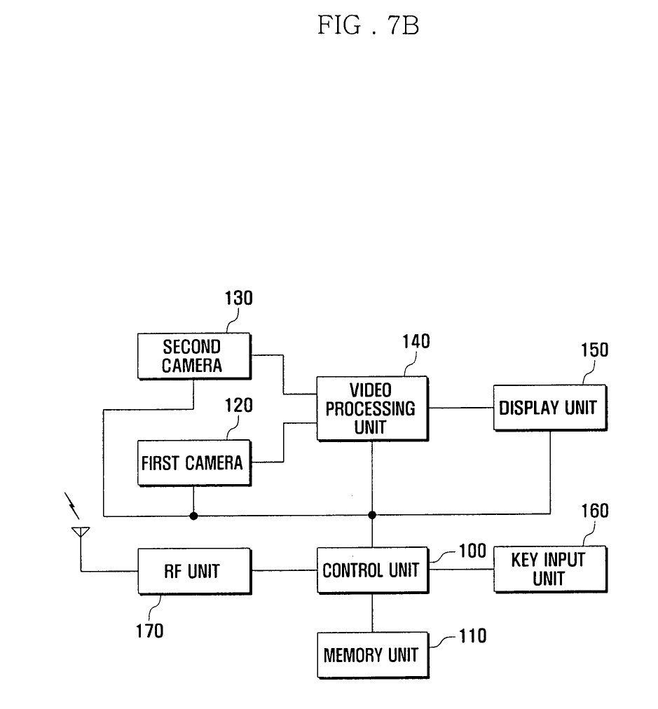

FIG. 7A is a pair of perspective views illustrating mobile terminals equipped with two cameras for implementing an image processing method according to an exemplary embodiment, and FIG. 7B is a diagram illustrating a configuration of each mobile terminal of FIG. 7A.

Referring to FIG. 7A, two cameras 120 and 130 are installed to be exposed outside a housing of the mobile terminal. The two cameras are arranged with a predetermined distance horizontally. The distance between the cameras 120 and 130 can be configured through the configuration of the mobile terminal and it is preferably over 2 cm. It is preferred that the cameras 120 and 130 are arranged in consideration of average distance between human eyes. The two cameras are configured to take images corresponding to the left and right eye images of the human vision system.

Referring to FIG. 7B, the mobile terminal includes a radio frequency (RF) unit 170 responsible for radio communication. The control unit 100 can be a mobile station modem. The control unit 100 controls the RF unit 170 as well as the 2D and 3D image processing functions. The mobile terminal can be configured in such way that the memory unit 110, key input unit 160, and display unit 150 are shared by the communication function and image processing function.

As described above, the image processing apparatus of the present invention enables storing a 3D image in a 2D image file format. Also, the image processing apparatus of the present invention is advantageous in processing both the 2D and 3D image files. Also, the image processing apparatus generates a 3D image file that can be compatible with 2D display device as well as 3D display device, resulting in compatibility enhancement between imaging devices.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An image file format comprising:
an image start segment for indicating a start of an image file;
an image information segment for storing information on the image file;
a two-dimensional image segment for storing first two-dimensional image data; and
an image end segment for indicating an end of the image file, wherein the image information segment comprises a variable length information field to indicate whether the image information segment contains a three-dimensional image and three-dimensional image data.

2. The image file format of claim 1, wherein the image file is a Joint Photographic Experts Group (JPEG) file.

3. The image file format of claim 2, wherein the image information segment comprises a thumbnail segment of an exchangeable image file format (Exif) segment.

4. The image file format of claim 3, wherein the thumbnail segment comprises:
a thumbnail tag segment for indicating a three-dimensional image;
a three-dimensional information segment for containing information on the three-dimensional image;
a three-dimensional data segment for containing data of the three-dimensional image;
an image end segment for indicating an end of the three-dimensional image.

5. The image file format of claim 3, wherein the image information segment comprises:
a comment segment for the three-dimensional image; and
a user comment segment containing an Eexif segment for containing a three-dimensional image header.

6. The image file format of claim 3, wherein the image information segment comprises:
a comment segment for the three-dimensional image; and
a specific segment containing an Exif segment for containing a three-dimensional image header.

7. The image file format of claim 3, wherein the three-dimensional image is an image generated by combining the first two-dimensional image and a second two-dimensional image taken at an angle different from an angle of the first tow-dimensional image.

8. An image processing apparatus comprising:
at least a first camera and a second camera installed with a predetermined distance for obtaining a first image and a second image, respectively;
a video processing unit for generating a three-dimensional image by combining the first image and the second image;
a control unit for controlling generation of an image file using the first image and the three-dimensional image;
a memory unit for storing the image file; and
a display unit having a parallax barrier for displaying the three-dimensional image with a three-dimensional effect or as a 2-dimensional image under a control of the control unit.

9. The image processing apparatus of claim 8, wherein the control unit controls the three-dimensional image to be stored in an image file format having an image start segment for indicating a start of the three-dimensional image, an image information segment for containing information of the three-dimensional image, a first image data segment for containing data of the first image, and an image end segment for indicating an end of the three-dimensional image, the image information segment containing information and data of the three-dimensional image in association with the 2-dimensional image.

10. The image processing apparatus of claim 9, wherein the image file is a Joint Photographic Experts Group file.

11. The image processing apparatus of claim 10, wherein the three-dimensional image information and data are contained in a thumbnail segment of an exchangeable image file format segment.

12. The image processing apparatus of claim 11, wherein the thumbnail segment comprises:
a thumbnail tag segment for indicating a presence of the three-dimensional image;
a three-dimensional information segment for containing information on the three-dimensional image;
a three-dimensional data segment for containing data of the three-dimensional image; and
an image end segment for indicating an end of the three-dimensional image.

13. The image processing apparatus of claim 10, wherein the video processing unit comprises:
a combiner for generating the three-dimensional image by combining the first image and the second image;
a video encoder for outputting an encoded image file by encoding the first image and the three-dimensional image; and
a video decoder for decoding the encoded image file.

14. The image processing apparatus of claim 10, wherein the video processing unit comprises:
a video encoder for encoding the first image and the second image separately;
a video decoder for decoding the encoded first image and the encoded second image; and
a combiner for generating a three-dimensional image by combining the encoded first image and the encoded second image line by line.

15. The image processing apparatus of any of claims 13 and 14, wherein the video processing unit comprises:
a plurality of scalers for scaling sizes of the first image and the second image to match a size of a display unit; and
a color converter for converting color data of the first image and the second image to match color data of the display unit.

16. An image storage method for an image processing apparatus having a first camera and a second camera installed with a predetermined distance, comprising:
capturing a first image input and a second image input from the first camera and the second camera;
generating a three-dimensional image by combining the first image and the second image; and
storing the three-dimensional image as an image file.

17. The image storage method of claim 16, wherein storing the three-dimensional image as the image file comprises:
inserting image start information in an image start segment of the image file;
including information on the three-dimensional image in an image information segment of the image file;
including data of the first image in a first image segment of the image file;
inserting an image end information in an image end segment of the image file; and
including information on the three-dimensional image associated with the two-dimensional image and three-dimensional image data in the image information segment.

18. The image storage method of claim 17, wherein the image file is a Joint Photographic Experts Group file.

19. The image storage method of claim 18, wherein the image information segment comprises a thumbnail segment of an exchangeable image file format segment.

20. The image storage method of claim 19, wherein the thumbnail segment comprises:
a thumbnail tag segment for indicating a presence of the three-dimensional image;
a three-dimensional information segment for containing information on the three-dimensional image;
a three-dimensional data segment for containing data of the three-dimensional image;
an image end segment for indicating an end of the three-dimensional image.

21. An image processing method for an image processing apparatus having a first camera and a second camera installed with a predetermined distance, comprising:
obtaining a first image and a second image by using the first camera and the second camera;
generating an image file generated by encoding the first image and the second image in an image storage mode; and
producing a three-dimensional image by decoding the first image and the second image from the image file and combining the first image and the second image.

22. The image processing method of claim 21, wherein generating the image file comprises:
inserting image start information in an image start segment of the image file;
including information on the first image in an image information segment of the image file;
including data of the first image in an image segment of the image file;
inserting image end information in an image end segment of the image file; and
including information on the second image and second image data in the image information segment.

23. The image processing method of claim 22, wherein the image file is a Joint Photographic Experts Group (JPEG) file.

24. The image processing method of claim 23, wherein the image information segment comprises a thumbnail segment of an exchangeable image file format segment, and the thumbnail segment comprises a thumbnail tag segment for indicating a presence of the three-dimensional image; a three-dimensional information segment for containing information on the three-dimensional image; a three-dimensional data segment for containing data of the three-dimensional image; an image end segment for indicating an end of the three-dimensional image.

25. An image processing method for an image processing apparatus having a first camera and a second camera installed with a predetermined distance, comprising:
switching on a three-dimensional image display function of a display with activations of the first camera and the second camera in a three-dimensional image processing mode;
displaying a three-dimensional image generated by combining a first image and a second image input from the first camera and the second camera;
storing an image file produced by encoding the first image and the three-dimensional image in an image recording mode; and
replaying the three-dimensional image reproduced by decoding the three-dimensional image from the image file in a three-dimensional image replay mode.
